(19) United States
(12) Patent Application Publication
(10) Pub. No.: US 2024/0102259 A1
(43) Pub. Date: Mar. 28, 2024

(54) AUTONOMOUS WATER VESSEL WITH OIL-WATER SEPARATOR

(71) Applicant: Clean Green Oil Inc., Toronto (CA)

(72) Inventor: Babak Khodaparast, Toronto (CA)

(21) Appl. No.: 18/373,438

(22) Filed: Sep. 27, 2023

Related U.S. Application Data
(60) Provisional application No. 63/410,322, filed on Sep. 27, 2022.

(51) Int. Cl. E02B 15/04; B01D 17/02; B63B 35/32; B63B 79/40; C02F 1/28; C02F 1/40; G05D 1/00; G05D 1/02

(52) U.S. Cl. CPC E02B 15/046; B01D 17/0202; B63B 35/32; B63B 79/40; C02F 1/28; C02F 1/40; E02B 15/045; G05D 1/0022; G05D 1/0206; C02F 2103/007

(57) ABSTRACT

A water vessel can include an inlet for receiving a solution from a body of water, an oil-water separator, and a bag coupled to the oil-water separator. The oil-water separator can separate at least a portion of oil in the solution from water, and the bag can store at least a portion of the oil. The oil-water separator can include a filter arranged adjacent to the inlet and allow oil to pass through. The water vessel can include a pump for transporting the oil from the oil-water separator to the bag. The water vessel can be configured for remote operation and/or autonomous operation on the body of water.

### CROSS-REFERENCE TO RELATED APPLICATION

This application claims priority to U.S. Provisional Application No. 63/410,322 filed Sep. 27, 2022, the entire contents of which are hereby incorporated herein by reference.

### FIELD

The present disclosure relates generally to autonomous watercraft and oil-water separation.

### BACKGROUND

The following paragraphs are not an admission that anything discussed in them is prior art or part of the knowledge of persons skilled in the art.

Oil and chemical spills at sea from ships, oil wells, offshore platforms, and the like result in many environmental and economic losses. Studies on the fate of oil pollution in the seas and the process of sea self-purification show that light petroleum substances can evaporate, aromatic substances can become somewhat soluble, and heavy compounds can come to the shore or deposit in the form of tarballs in the seabed. The other compounds can be mixed as suspended particles in seawater. In this way, the toxicity of oil in seawater over time and its physical and chemical changes can decrease. Small amounts of these compounds can be broken down by bacteria and other organisms.

To separate oil from water, it is necessary to choose materials with high capacity and good resistance to oil deposition and can be used frequently. Among different materials, hydrogels seem to be a suitable option for designing water and oil separation filters due to their high water absorption and storage power. There are existing methods for separating oil from water, which may not be cost-effective and time consuming due to relatively high operating costs, low efficiency, and large equipment requirements. Existing methods of oil-water separation can also be difficult to carry out on water and at offshore locations.

### INTRODUCTION

The following is intended to introduce the reader to the detailed description that follows and not to define or limit the claimed subject matter.

The present disclosure relates generally to apparatuses and related methods of oil-separation that can, for example, be carried out on the surface of a body of water autonomously, remotely, and/or with low energy consumption.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of apparatuses and methods of the present disclosure and are not intended to limit the scope of what is taught in any way. In the drawings:

FIG. 1 is a perspective view of an exemplary water vessel;

FIG. 2 is a side cutaway view of an oil-water separator of the water vessel; and

FIG. 3 is a side sectional view of a filter box.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

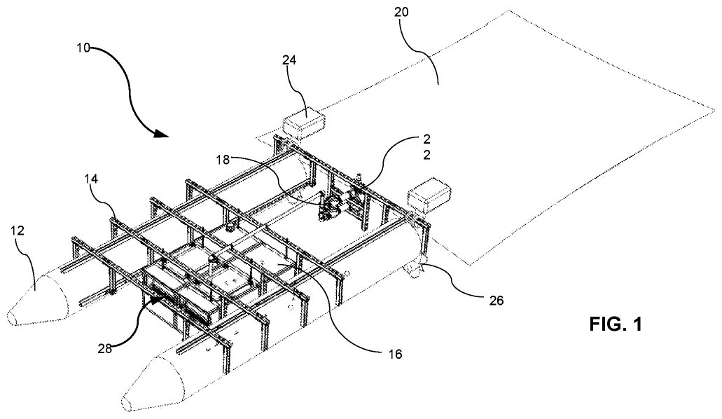

Referring to FIG. 1, a water vessel is shown generally at reference numeral 10. In the example illustrated, the water vessel 10 is shown to include two pontoons 12, which are used to keep the device afloat. In use, the water vessel 10 can stay afloat, travel across a body of water, collect water, and separate oil from the water.

As used herein, the term “oil” can refer to various mineral, vegetable and animal oils, many different hydrocarbons, and/or other chemical materials that can act as waterborne pollutants.

The pontoons 12 are shown connected to other components of the device by a support structure 14. In the example illustrated, an oil-water separator 16 is supported by the support structure 14 intermediate of the pontoons 12, and is installed such that, in use, about half of the oil-water separator 16 can be submerged in water, and an upper portion can be out of the water.

In the example illustrated, a pump 18 is arranged to transport oil collected in the oil-water separator 16 to a collection bag 20. After oil inflow to the first collection bag 20 reaches its maximum, it can be disconnected from the suction pump 18 and removed from the water vessel 10. Another bag can then be taken out of a box 22 to replace the previous oil bag. The full bag can float on the water to be transported to shore by boats at the end of the collection process.

In the example illustrated, energy required for operation of the water vessel 10 is supplied by electric batteries 24. In some examples, the batteries 24 can be charged by solar panels (not shown), which can be located on an upper surface of the water vessel 10. Under each of the batteries 24 is shown respective propulsion blades 26, which can be supplied energy from the batteries 24 to guide the water vessel 10 forward.

In use, the water vessel 10 can move slowly across a body of water, and water and oil solution can enter an inlet 28 for treatment with the oil-water separator 16, as described in further detail below.

In some examples, the water vessel 10 can further include suitable hardware and software to effect control for unmanned navigation, including remote and/or autonomous cruising. In some examples, the water vessel 10 can further include a combination of LiDAR, sensors, and software to enable remote and/or autonomous control by satellite.

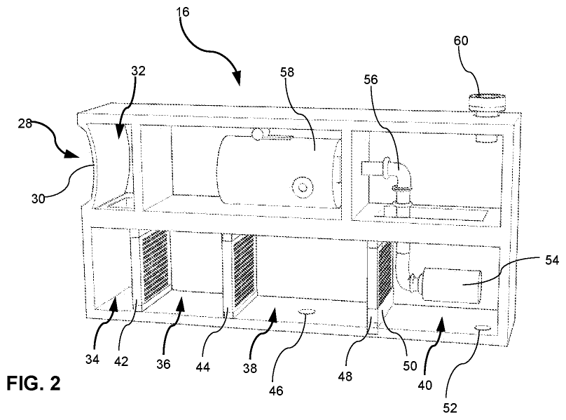

Referring to FIG. 2, the inlet 28 is arranged at a front of the oil-water separator 16. In use, the inlet 28 can be at least partially submerged in water. In the example illustrated, the inlet 28 includes a permeable panel 30 that presents a concave outer facing surface. The permeable panel 30 can include a suitable hydrophobic filter to allow oil and/or chemical pollutants to pass into the device to a first chamber 32 as a solution enters the inlet 28 but prevents water from entering.

Various types of filters can be implemented at the permeable panel 30. In some examples, the permeable panel 30 can include a carbon coated filter. In some examples, the permeable panel 30 can include a carbon nanotube filter. In some examples, the permeable panel 30 can include an oil-water separator filter in accordance with the teachings of International Application No. PCT/162021/060565 filed Nov. 15, 2021, the entire contents of which are hereby incorporated by reference.

In use, the solution can pass through the inlet 28 and the permeable panel 30 to the first chamber 32, and then can flow downwardly by force of gravity to enter a lower portion of the oil-water separator 16, which can consist of four storage sections 34, 36, 38, 40, as illustrated.

In the example illustrated, a permeable wall 42 is arranged between the sections 34, 36. The wall 42 can be composed of, for example, a lattice metal plate. The solution can slowly pass through the lattice of the wall 42 and enter the second section 36 of the lower portion of the oil-water separator 16. This can result in turbulence of the solution and, due to the difference in volume mass, the oil of the solution can rise to the surface.

In the example illustrated, after passing through the next lattice wall 44, the solution reaches the third section 38 of the lower portion of the oil-water separator 16. At the bottom of this section, there is an outlet 46 that can include a hydrophilic filter, so if water has entered the third section 38 from the previous steps, it can exit via the outlet 46.

In the example illustrated, the next lattice wall 48, which is between the third and fourth sections 38, 40, includes a lower portion 50 that can be non-permeable, which can help prevent water from being transferred to the fourth section 40 and remain in the third section 38.

In the example illustrated, the bottom of the fourth section 40 also includes an outlet 52, which can include a hydrophilic filter and be used to exit any water out of the floor of this section.

In the example illustrated, in the fourth section 40, there is a valve 54 with an oil inlet. In some examples, the valve 54 can include a hydrophobic filter located at the inlet to ensure entry of substantially pure oil and/or other chemical pollutants. In some examples, the filter can include a carbon coated filter, a carbon nanotube filter, and/or an oil-water separator.

In the example illustrated, the valve 54 is connected by a conduit 56 to a temporary tank 58 which, due to suction of the pump 18 of the water vessel 10 (FIG. 1), sucks the collected oil and transfers it to the bag. To control the pressure of fluids in the sections, a pressure control valve 60 can be located above the fourth section 40, as illustrated.

The water vessel 10 can provide several advantages, including: it can be operated fully automatically and without the need for an operator; it can be easy to maintain; it can avoid the need for expensive consumables to separate water from oil; it can be possible to collect oil from water at the source of pollution; it can be possible to collect a full oil bag and transfer it to the shore while the machine continues to work; and/or it can be deployed to remote locations by helicopters or ships.

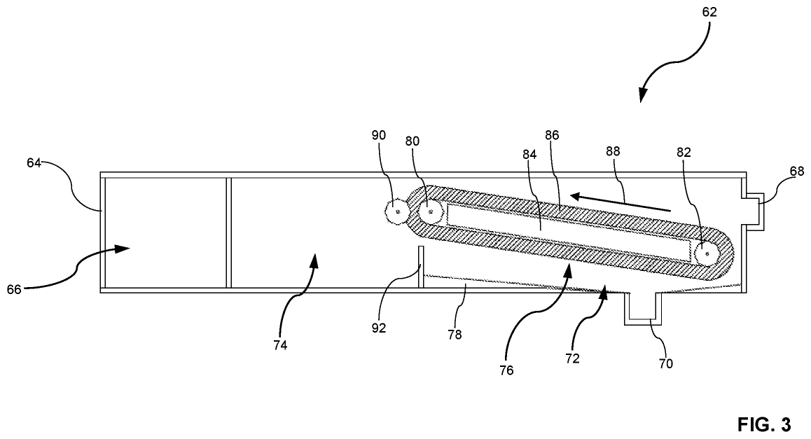

Referring to FIG. 3, a filter box is shown generally at reference numeral 62. In some examples, the filter box 62 can be implemented with the water vessel 10 as a means of providing fluid separation. In some examples, the filter box 62 can be provided as an alternative to the oil-water separator 16. In some examples, the filter box 62 can be provided in addition to the oil-water separator 16.

In the example illustrated, the main frame or housing of the device is indicated at reference numeral 64. Arranged at one end of the housing 64, a control section 66 can house electronics and other components used for operating the filter box 62. Arranged at the other end of the housing 64, the filter box 62 includes an entrance valve 68. Below the entrance valve 68, the filter box 62 includes an exit valve 70. Water is configured to flow by force of gravity between the valves 68, 70. The valves 68, 70 can be individually controllable to adjust the water pumping pressure and promote maximum discharge.

In the example illustrated, a separation section 72 is disposed between the valves 68, 70. A storage section 74 is adjacent to the separation section 72. Within the separation section 72 there is arranged a conveyor mechanism 76, which is designed to collect oil, move it upwardly away from water, and deliver it to the section 74, while permitting the water to descend towards the exit valve 70. As shown, surrounding the exit valve 70, diagonal plates 78 can be provided to create a slope at a bottom of the section 72 to urge water towards the exit valve 70 for collection. In some examples, a pump can be used to draw water through the exit valve 70 to piping.

In the example illustrated, the conveyor mechanism 76 includes first and second rollers 80, 82, a fixed plate 84 arranged between the first and second rollers 80, 82, and a belt 86 that is driven to move around these components. The direction of movement is indicated at 88. At least one of the rollers 80, 82 can be driven to effect movement of the belt 86. The first roller 80 can be arranged near an entrance to the section 74, roughly above a partition 92 between the sections 74, 76. As illustrated, the first roller 80 can be positioned above the second roller 82 so that the conveyor mechanism 76 is inclined at an angle.

In some examples, the conveyor belt 86 can include a flexible and resilient inner layer, which can be made out of rubber or another suitable material, and an absorbent outer layer that is adapted to collect the oil, which can be made out of sponge or another suitable material. In some examples, the outer layer can be formed of materials that are adapted to collect pollutants and chemicals other than oil.

In the example illustrated, the conveyor mechanism 76 further includes a squeegee device in the form of a roller 90 in the section 74, offset inwardly relative to the partition 92. The roller 90 can be arranged to continuously compress the outer layer of the belt 86 and thereby induce oil droplets into the section 74. The oil that is delivered to the storage section 74 can then exit the filter box 62 via an oil exit valve. In some examples, the oil can be pumped to a collection bag, as described above.

In some examples, one or more additional filter boxes can be implemented modularly in a multipurpose water vessel, and used as a means of retrieving debris from water, including seaweed or plastics, for example. In such examples, the conveyor can be adapted to pick up the debris in the separation section and deliver it to the storage section, where it is stored until it can be properly disposed of.

While the above description provides examples of one or more apparatuses or methods, it will be appreciated that other apparatuses or methods may be within the scope of the accompanying claims.

I claim:

1. A water vessel, comprising:
an inlet for receiving a solution from a body of water;
an oil-water separator; and
a bag coupled to the oil-water separator,
wherein the oil-water separator is configured to separate at least a portion of oil in the solution from water, and
wherein the bag is configured to store at least a portion of the oil.

2. The water vessel of claim 1, wherein the oil-water separator comprises a filter arranged adjacent to the inlet and configured to allow oil to pass through.

3. The water vessel of claim 2, wherein the oil-water separator comprises two or more storage sections arranged below the filter to receive the oil.

4. The water vessel of claim 3, wherein the oil-water separator comprises at least one permeable wall separating two of the sections.

5. The water vessel of claim 4, wherein the oil-water separator comprises at least one water outlet at the bottom of at least one of the sections.

6. The water vessel of claim 5, wherein the oil-water separator comprises an oil inlet in one of the sections.

7. The water vessel of claim 6, wherein the oil inlet comprises a filter configured to allow oil to pass through.

8. The water vessel of claim 7, wherein the oil-water separator comprises a tank connected to the oil inlet.

9. The water vessel of claim 1, comprising a pump for transporting the oil from the oil-water separator to the bag.

10. The water vessel of claim 1, comprising pontoons for floating the water vessel on the body of water.

11. The water vessel of claim 1, wherein the water vessel is configured for remote operation on the body of water.

12. The water vessel of claim 1, wherein the water vessel is configured for autonomous operation on the body of water.

13. A method, comprising:
providing a water vessel comprising an inlet, an oil-water separator coupled to the inlet, and a bag coupled to the oil-water separator;
operating the apparatus on a body of water;
with the inlet, receiving a solution from the body of water;
with the oil-water separator, separating at least a portion of oil in the solution from water; and
storing at least a portion of the oil in the bag.

14. The method of claim 14, comprising at least one of:
operating the apparatus remotely on the body of water;
operating the apparatus autonomously on the body of water; and
controlling the water vessel by satellite.

15. A filter box, comprising:
a housing comprising a separation section, and a storage section adjacent to the separation section; and
a conveyor mechanism comprising at least one roller, and a belt configured to be driven around the at least one roller,
wherein the separation section is configured to receive a solution from a body of water,
wherein the belt is configured to collect from the separation section at least a portion of oil in the solution from water and deliver it to the storage section, and
wherein the remaining portion of the solution is retained in the separation section.

16. The filter box of claim 15, wherein the separation section comprises an entrance valve, and an exit valve below the entrance valve.

17. The filter box of claim 16, wherein the at least one roller comprises a first roller positioned above a second roller so that the conveyor mechanism is inclined at an angle.

18. The filter box of claim 17, wherein the belt comprises a flexible and resilient inner layer, and an absorbent outer layer.

19. The filter box of claim 18, wherein the conveyor mechanism comprises a squeegee device arranged to compress the absorbent outer layer for inducing oil into the storage section.

20. A water vessel comprising the filter box of claim 15.
